(19) United States
(12) Patent Application Publication
(10) Pub. No.: US 2020/0211382 A1
(43) Pub. Date: Jul. 2, 2020

(54) ON-DEMAND STOP SIGN FOR LEFT-TURN AT T-JUNCTION INTERSECTION

(71) Applicant: Continental Automotive Systems, Inc., Auburn Hills, MI (US)

(72) Inventor: Anjun Lu, Vernon Hills, IL (US)

(21) Appl. No.: 16/720,959

(22) Filed: Dec. 19, 2019

Related U.S. Application Data
(60) Provisional application No. 62/786,489, filed on Dec. 30, 2018.

(51) Int. Cl. G08G 1/087; G08G 1/01; G08G 1/08

(52) U.S. Cl. CPC G08G 1/087; G08G 1/08; G08G 1/0145

(57) ABSTRACT

A turn-on signal is transmitted from an in-vehicle stop-sign-command transmitter in a vehicle waiting to make a left turn from a first direction of travel to an on-demand stop sign for a second direction of travel, which is opposite to the first direction of travel. Reception of the turn-on signal by the on-demand stop sign causes the on-demand stop sign to transition from off to on thereby causing traffic in the second direction to yield the right of way to the vehicle waiting to make the left turn. After the vehicle waiting to make the left turn has made the left turn, the stop sign is turned back off again.

### BACKGROUND

Embodiments of the invention are directed to facilitating difficult left-turns at a T-junction intersection from a major one-lane roadway onto a minor roadway while traffic conditions are heavy on the major one-lane roadway.

A T-junction is an intersection at which a minor roadway meets a major roadway. The minor roadway at a T-intersection is typically controlled by a stop sign, whereas the vehicles on the major roadway continue driving without having to stop.

At a T-junction intersection of, it is sometimes time-consuming to make a left turn from the major roadway onto the minor roadway when traffic in the opposite direction on the major roadway is heavy. Not only does the driver have to wait for a long time until the traffic on the opposite direction is clear or make an unsafe hurried left-turn, under these circumstances, the vehicle waiting to make a left turn unfortunately blocks the traffic behind it that, but for the vehicle waiting to turn left, would be travelling past the T-junction on the major roadway. Of course, the heavier that traffic conditions are on the major roadway, such as during rush hour, the longer the delays will be.

Improved techniques for managing traffic flow at T-junction intersections would advance the state of the art.

### BRIEF SUMMARY

In accordance with embodiments of the invention, A turn-on signal is transmitted from an in-vehicle stop-sign-command transmitter in a vehicle waiting to make a left turn from a first direction of travel to an on-demand stop sign for a second direction of travel, which is opposite to the first direction of travel. Reception of the turn-on signal by the on-demand stop sign causes the on-demand stop sign to transition from off to on thereby causing traffic in the second direction to yield the right of way to the vehicle waiting to make the left turn. After the vehicle waiting to make the left turn has made the left turn, the stop sign is turned back off again.

### BRIEF DESCRIPTION OF THE DRAWINGS

FIG. 1 depicts a T-junction intersection with a plurality of vehicles travelling along the major roadway.

FIG. 2 depicts a telematics control unit and an in-vehicle stop-sign-command transmitter in accordance with embodiments of the invention.

### DETAILED DESCRIPTION

In accordance with embodiments of the invention, when a vehicle stops at a T-junction intersection on a one-lane major roadway in preparation for making a left turn onto the minor roadway of the T-junction intersection, a wireless communication module of the vehicle may signal a stop sign to enable the stop sign to stop traffic travelling toward the T-junction intersection on the major roadway from the opposite direction so that the vehicle that is stopped can make a left turn safely and allow the traffic behind the turning vehicle to no longer be blocked by the vehicle waiting to turn left so that the vehicle behind the turning vehicle can then proceed along the major roadway through the T-junction intersection.

In this way, embodiments of the invention achieve two purposes during heavy traffic conditions, such as rush hour: (1) allow a safe left turn at the intersection without a traffic light; and (2) un-block the traffic in the lane from which the vehicle is turning left.

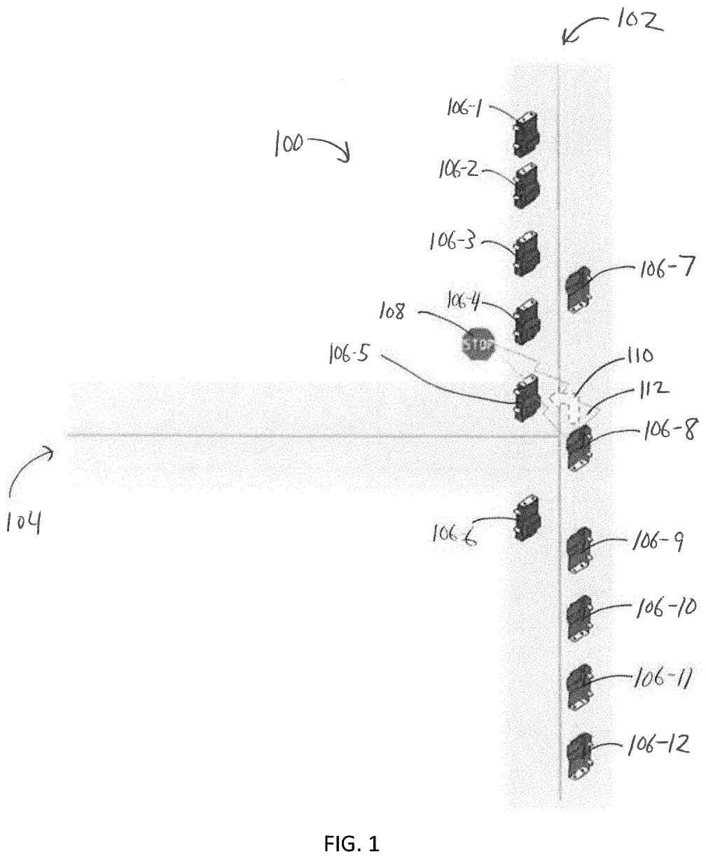

FIG. 1 depicts a T-junction intersection 100 with a plurality of vehicles 106-1 through 106-12 travelling along the major roadway 102. Vehicle 106-8 is waiting to make a left turn 110 onto minor roadway 104. But vehicle 106-8 has to yield to vehicles 106-1 through 106-5, thereby delaying vehicle 106-8 and vehicles 106-9 through 106-12, which are blocked by vehicle 106-8 while it occupies the only lane in that direction of the major roadway at the T-junction intersection 100.

In accordance with embodiments of the invention a wireless communication module of the vehicle 106-8 may transmit a wireless signal 110 to on-demand stop sign 108 to inform the on-demand stop sign 108 that the vehicle 106-8 is waiting to turn left from the major roadway onto the minor roadway. Such a signal may be sent automatically upon the driver of vehicle 106-8 activating the vehicle's left-turn signal. The on-demand stop sign may determine whether traffic conditions are heavier than a predetermined threshold or the on-demand stop sign may have set times, for example, 7-9 AM and 4-6 PM, during which such a wireless communication will cause the on-demand stop sign to display a stop signal to traffic approaching the T-junction intersection from the opposite direction (i.e., vehicles 106-1 through 106-4 in FIG. 1). When traffic is either less heavy than a predetermined threshold and/or when it is not rush hour, the on-demand stop sign may disregard the wireless communication from the vehicle 106-8.

In accordance with embodiments of the invention the on-demand stop sign may be a stop sign that is normally off and turns on when receiving a wireless signal from a vehicle turning left, such as vehicle 106-8. The on-demand stop sign may also be a on-demand stop sign that is normally green, but changes to yellow and then red upon receiving the wireless signal 110 from a vehicle that is waiting to turn left. The on-demand stop sign may include a processor, a memory, a communication interface, an antenna assembly, and a power supply, and an output device for displaying an indication that oncoming traffic should stop and, in some embodiments, a down counter or other suitable indication that the on-demand stop sign is about to indicate that oncoming traffic should stop. Similarly, a telematics control unit of the vehicle may include a processor, a memory, a communication interface, an antenna assembly, and a power supply.

The wireless communication 110 may be any type of wireless communication, including, but not limited to, Dedicated Short-Range Communications, cellular communications, Wifi, Infrared, and the like.

In accordance with embodiments, to allow the blocking vehicle 106-8 to make a left turn safely during heavy-traffic conditions without blocking other vehicles 106-9 through 106-12 for too long a period of time, an ON-OFF switchable STOP sign 108 can be used together with a device in a vehicle. The device can enable the ON-OFF STOP sign when waiting for left-turn to stop the opposite traffic (i.e., vehicles 106-1 through 106-4) for a short time so that the vehicle 106-8 can safely make a left turn.

Embodiments of the invention may include:

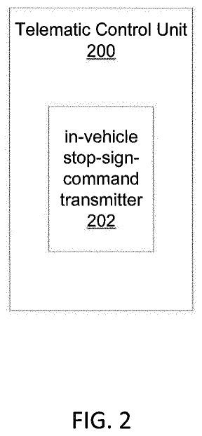

1) An in-vehicle stop-sign-command transmitter 202, which may be included in a Telematic Control Unit (TCU) 202, for example, as depicted in FIG. 2. The in-vehicle stop-sign-command transmitter may emit a command signal to communicate with a roadside stop sign that is manually operable to be turned on temporarily to stop oncoming traffic to allow a vehicle from an opposite direction to obtain the right of way to turn left and then to turn off the roadside stop sign to allow oncoming traffic to begin flowing again following the left turn being completed.

2) A roadside stop sign 108 that is manually operable between an On and an Off state to selectively stop traffic to provide a right of way to a vehicle in the opposite direction to turn left while oncoming traffic is stopped and then to be turned off to allow oncoming traffic to begin to flow again. In accordance with embodiments of the invention, the stop sign may wait a predetermined period of time (e.g., 60 seconds) during which the vehicle waiting to turn left is transmitting a command to turn on the stop sign before the stop sign actually turns on to stop traffic. The stop sign may display a count down during that last 15 seconds, for example, before signaling oncoming traffic to stop.

Embodiments of the invention may include the following principles of operation:

1) On a single-lane road (i.e., a single lane of travel in one or both directions) when the traffic in both directions is heavy, a vehicle equipped with such a TCU stops and is ready make a left turn;

2) The TCU begins to emit a signal upon the vehicle making a full stop and the driver pushing a button (or simply turning on the left-turn signal) to start the process. The TCU may receive an acknowledgement from the stop sign within a predetermined timeout period (e.g., 5 seconds), otherwise the TCU may stop emitting the signal since the ON-OFF stop sign is not present at a particular intersection or is not functioning normally.

In some embodiments, when a vehicle's navigation system determines that the vehicle is approaching a T-junction intersection and the current route guidance involves making a left turn at the T-junction intersection under heavy traffic conditions (e.g., a wait of greater than 30, 60, or 90 seconds will likely be involved), then the telematics control unit may automatically decide to activate the on-demand stop sign based on this information from the vehicle's navigation system.

3) The ON-OFF STOP Sign may respond with an acknowledging signal, and switch ON if signal exchange remains for a period of time (i.e. 30 seconds or 1 minute. During this period, the sign may blink, display a count down until it turns on, display a yellow light, and the like, to warn the vehicles in the opposite lane);

4) The opposite traffic will then stop when seeing the STOP sign being turned on to allow the turning vehicle 106-8 to make a left-turn safely, thus also unblocking the same way traffic (i.e., vehicles 106-9 through 106-12).

5) After making the left turn, the vehicle may stop emitting the signal, and the ON-OFF STOP sign will turn itself off to allow the opposite vehicles 106-1 through 106-4 to continue moving; or the STOP sign may turn itself off in 15 seconds (or other period of time, say 30 seconds, etc) after being turned on.

FIG. 1 depicts an intersection in which a vehicle (in the right hand land travelling toward the top of FIG. 1) is waiting to turn left and communicates wirelessly with a stop sign for traffic travelling in the opposite direction (i.e., downward in the left hand lane in FIG. 1). Once the stop sign turns on, the vehicles travelling downward in the right-hand lane in FIG. 1 would stop to allow the vehicle to turn left. In addition to allowing the vehicle to turn left, the vehicles behind that vehicle (i.e., below it in FIG. 1) will then be unblocked and able to proceed (i.e., upward in FIG. 1). And once the stop sign turns off, the traffic in the right-hand lane travelling downward in FIG. 1 would then begin moving again.

While the present invention has been illustrated by a description of various embodiments and while these embodiments have been described in considerable detail, it is not the intention of the applicants to restrict or in any way limit the scope of the appended claims to such detail. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit or scope of applicant's general inventive concept.

1. A method comprising:
transmitting a turn-on signal, from an in-vehicle stop-sign-command transmitter in a vehicle waiting on a major roadway at a T-junction intersection to make a left turn from a first direction of travel, to an on-demand stop sign for a second direction of travel, which is opposite to the first direction of travel, along the major roadway, such that reception of the turn-on signal by the on-demand stop sign causes the on-demand stop sign to transition from off to on thereby causing traffic in the second direction to yield the right of way to the vehicle waiting to make the left turn and then, after the vehicle waiting to make the left turn has made the left turn, stopping transmission of the turn-on signal such that the on-demand stop sign will turn back off again.

2. The method of claim 1, further comprising: a telematics control unit beginning to emit the turn-on signal upon at least one of: the vehicle making a full stop and a driver of the vehicle doing at least one of: pushing a button and turning on the left-turn signal, and a navigation system of the vehicle automatically determining that the turn-on signal should be transmitted based on route-guidance information of the navigation system.

3. An in-vehicle stop-sign command transmitter configured to perform operations comprising:
transmitting a turn-on signal, from an in-vehicle stop-sign-command transmitter in a vehicle waiting on a major roadway at a T-junction intersection to make a left turn from a first direction of travel, to an on-demand stop sign for a second direction of travel, which is opposite to the first direction of travel, along the major roadway, such that reception of the turn-on signal by the on-demand stop sign causes the on-demand stop sign to transition from off to on thereby causing traffic in the second direction to yield the right of way to the vehicle waiting to make the left turn and then, after the vehicle waiting to make the left turn has made the left turn, stopping transmission of the turn-on signal such that the on-demand stop sign will turn back off again.

4. The in-vehicle stop-sign command transmitter of claim 6, further configured to perform operations comprising: beginning to emit the turn-on signal upon at least one of: the vehicle making a full stop and a driver of the vehicle doing at least one of pushing a button and turning on the left-turn signal, and a navigation system of the vehicle automatically determining that the turn-on signal should be transmitted based on route-guidance information of the navigation system.

5. An on-demand stop sign for a first direction of travel, the on-demand stop sign being configured to perform operations comprising:
receiving a turn-on signal, from an in-vehicle stop-sign-command transmitter in a vehicle waiting on a major roadway at a T-junction intersection to make a left turn from a second direction of travel, which is opposite to the first direction of travel, along the major roadway, whereby reception of the turn-on signal by the on-demand stop sign causes the on-demand stop sign to transition from off to on thereby causing traffic in the second direction to yield the right of way to the vehicle waiting to make the left turn and then, after the vehicle waiting to make the left turn has made the left turn and has stopped transmission of the turn-on signal, turning the on-demand stop sign back off again.

6. The on-demand stop sign of claim 5, wherein: the stop sign waits a predetermined period of time during which the vehicle waiting to turn left is transmitting a command to turn on the on-demand stop sign before the on-demand stop sign actually turns on to stop traffic.

7. The on-demand stop sign of claim 6, wherein: during the predetermined period of time, the sign displays a count down until it turns on.
